(19) United States
(12) Patent Application Publication
(10) Pub. No.: US 2024/0354908 A1
(43) Pub. Date: Oct. 24, 2024

(54) IMAGE PROCESSING APPARATUS AND IMAGE PROCESSING METHOD

(71) Applicant: AXELL CORPORATION, Tokyo (JP)

(72) Inventor: Shuji Okuno, Nara (JP)

(73) Assignee: AXELL CORPORATION, Tokyo (JP)

(21) Appl. No.: 18/640,947

(22) Filed: Apr. 19, 2024

(30) Foreign Application Priority Data
Apr. 19, 2023 (JP) 2023-068528
Mar. 19, 2024 (JP) 2024-043763

(51) Int. Cl. G06T 5/60; G06T 3/4053; G06T 5/73; G06T 7/00

(52) U.S. Cl. CPC G06T 5/60; G06T 3/4053; G06T 5/73; G06T 7/0002; G06T 2207/20081; G06T 2207/20084; G06T 2207/30168

(57) ABSTRACT

To improve the quality of super-resolution performed on an image including a blurred portion, a method generates processed image data obtained by degradation processing performed on training image data based on a predetermined degradation processing parameter, causes a first machine learning model that discriminates a tag value in accordance with input image data to perform learning based on the processed image data and a tag value in accordance with the degradation processing parameter, causes a second machine learning model that generates output image data in accordance with input image data to perform learning based on training image data, the processed image data, and the tag value in accordance with the degradation processing parameter, performs inference using the first machine learning model on target image data that is a target of image processing as input, to output a tag value based on the target image data, and performs inference using the second machine learning model on this output tag value and the target image data to generate output image data based on the target image data.

### CROSS-REFERENCE TO RELATED APPLICATION

This application is based upon and claims the benefit of priorities to Japanese Patent Application No. 2023-68528, filed on Apr. 19, 2023, and Japanese Patent Application No. 2024-43763, filed on Mar. 19, 2024, with the Japanese Patent Office, the entire contents of which are incorporated herein by reference in its entirety.

### FIELD

The embodiments discussed herein are related to an image processing apparatus, an image processing method, and a non-transitory computer-readable recording medium.

### BACKGROUND

There are known image generation AI (generative AI) techniques such as GAN (Generative Adversarial Network) (Japanese Patent Application Laid-open No. 2020-205030).

Further, there is known a technique of generating a high-resolution image from a low-resolution image, called super-resolution, in connection with image generation. Super-resolution is a technique that predicts and restores high frequency components of a low-resolution image to increase the resolution, instead of simply enlarging the low-resolution image, thereby generating a high-resolution image. While an image obtained by simply enlarging the low-resolution image is blurred, super-resolution can increase the resolution while removing generated blur.

In connection with super-resolution, Real-ESRGAN (Training Real-World Blind Super-Resolution with Pure Synthetic Data, Xintao Wang, Liangbin Xie, Chao Dong, Ying Shan, 2021) has been proposed. In Real-ESRGAN, learning by the generator is performed while an image that has become blurred because of degradation processing performed on training image data on the output side is set as training image data on the input side.

Here, the training image data on the input side and the training image data on the output side are respectively training image data that is to be input to a machine learning model and training image data that is to be output from the machine learning model when the machine learning model performs learning. In image generation AI, a learning model is trained so as to obtain an image close to the output-side training image data by inputting the input-side training image data to the learning model and performing image processing.

By inputting image data to a machine learning model as a trained generator and performing inference, an image is generated. In a case of super-resolution described in Real-ESRGAN: Training Real-World Blind Super-Resolution with Pure Synthetic Data, a super-resolution image is generated which has the increased resolution and from which blur is removed.

### SUMMARY

However, in super-resolution described in Real-ESRGAN: Training Real-World Blind Super-Resolution with Pure Synthetic Data, image generation is performed without distinguishing whether input image data is data of a blurred image as a result of degradation processing or data of an image in which the background or the like is blurred based on the depth of field. As a result, all the blur below a certain level such as the background may be sharpened, so that an image different from an original image may be generated.

It is an object of an aspect of the present invention to improve the quality of super-resolution of an image including a blurred portion.

According to an aspect of the present invention, an image processing apparatus includes a learning unit configured to cause a machine learning model, outputting a value in accordance with predetermined input image data, to perform learning based on processed image data, obtained by degradation processing performed on image data based on a predetermined degradation processing parameter, and a value in accordance with the degradation processing parameter.

According to another aspect of the present invention, an image processing apparatus includes a learning unit configured to cause a machine learning model, generating output image data in accordance with predetermined input image data, to perform learning based on processed image data, obtained by degradation processing performed on image data based on a predetermined degradation processing parameter, the image data, and a value in accordance with the degradation processing parameter.

According to still another aspect of the present invention, an image processing apparatus includes: a learning unit configured to cause a first machine learning model capable of outputting a value in accordance with predetermined input image data to perform learning based on processed image data, obtained by degradation processing performed on image data based on a predetermined degradation processing parameter, and a value in accordance with the degradation processing parameter, and configured to cause a second machine learning model generating image data in accordance with predetermined input image data to perform learning based on the image data, the processed image data, and the value in accordance with the degradation processing parameter; and an inference unit configured to perform inference using the first machine learning model on target image data that is a target of image processing as input, to output a value based on the target image data, and configured to perform inference using the second machine learning model on the output value and the target image data as input to generate output image data based on the target image data.

According to an aspect of the present invention, it is possible to improve the quality of super-resolution of an image including a blurred portion.

### BRIEF DESCRIPTION OF DRAWINGS

FIG. 1 is a block diagram illustrating a configuration of an image processing apparatus according to the present embodiment;

FIG. 2 is a functional block diagram of the image processing apparatus;

FIG. 3 is a conceptual diagram for explaining learning by a discriminator according to the present embodiment;

FIG. 4 is an explanatory diagram of a table that defines the relation between the degree of degradation processing and a tag value;

FIG. 5 is an explanatory diagram of a table that defines the relation between the degree of degradation processing and a tag value;

FIG. 6 is an explanatory diagram of a table that defines the relation between the degree of degradation processing and a tag value;

FIG. 7 is a conceptual diagram for explaining how to derive a tag value in the discriminator of the present embodiment;

FIG. 8 is a conceptual diagram for explaining learning by a generator in the present embodiment;

FIGS. 9A and 9B are diagrams for explaining a tag value input to the generator of the present embodiment;

FIG. 10 is a diagram for explaining image generation processing executed by the image processing apparatus;

FIGS. 11A to 11D are diagrams for explaining an image generated by the image processing apparatus of the present embodiment;

FIGS. 12A and 12B are diagrams illustrating a first modification of the discriminator of the present embodiment;

FIG. 13 is a diagram illustrating a second modification of the discriminator of the present embodiment;

FIGS. 14A to 14D are diagrams for explaining how to identify a cropped position in an image;

FIG. 15 is a flowchart for explaining learning processing of the discriminator in the present embodiment;

FIG. 16 is a flowchart for explaining learning processing of the generator in the present embodiment;

FIG. 17 is a flowchart for explaining image generation processing in the present embodiment;

FIG. 18 is an explanatory diagram of a configuration of a generator according to a modification of the present embodiment;

FIG. 19 is an explanatory diagram of Channel Attention;

FIG. 20 is an explanatory diagram of Spatial Attention;

FIG. 21 is an explanatory diagram of Scaled Dot-Product Attention; and

FIG. 22 is a block diagram illustrating an example of a computer apparatus.

### DESCRIPTION OF EMBODIMENTS

An embodiment of the present invention is explained below in detail with reference to the drawings.

First, processing performed by an image processing apparatus according to the present embodiment is roughly described.

The image processing apparatus according to the present embodiment inputs target image data that is a target of super-resolution or the like and information on the degree of blur in the target image data to a trained generator, and performs image generation involving up-sampling.

The generator is a machine learning model that performs learning using training image data, processed image data obtained by degradation processing (e.g., reduction and Gaussian blur) performed on the training image data, and a numerical value indicating the degree of blur in the processed image data as a result of the degradation processing. By inputting the target image data and the information on the degree of blur in the target image data to the trained generator, image generation can be performed with increased resolution while blur caused by degradation processing and blur originally included in the target image data are distinguished from each other.

As a result, it is possible to sharpen only blur caused by increasing the resolution (up-sampling) without sharpening, for example, blur of the background caused by the depth of field that is originally included in the target image data.

Therefore, according to the present embodiment, the problem that an image different from the target image is generated can be solved, so that the quality of super-resolution can be improved.

The information on the degree of blur in the target image data input to the generator is obtained by inputting the target image data to a discriminator that is a characteristic configuration of the present embodiment. This discriminator is a machine learning model that learns a pair of processed image data obtained by performing degradation processing such as reduction and Gaussian blur on training image data and a numerical value indicating the degree of blur caused by the degradation processing. By inputting target image data to the trained discriminator, the information on the degree of blur in the target image data is obtained.

The machine learning model used in the present embodiment may be configured by, for example, a neural network, in particular, a convolutional neural network (CNN) including a convolution layer. In the following descriptions, a machine learning model is simply described as a learning model.

The image processing apparatus of the present embodiment is described in more detail below.

### Image Processing Apparatus

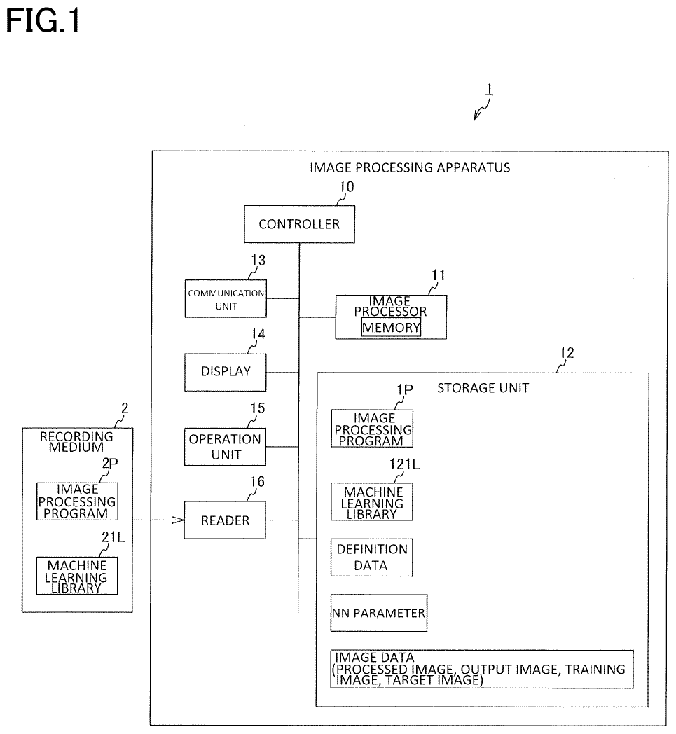

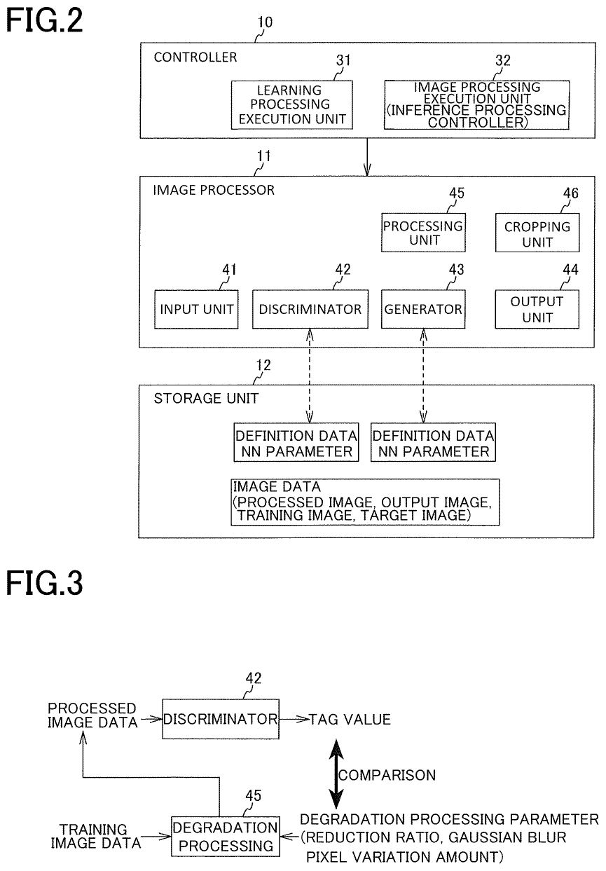

FIG. 1 is a block diagram illustrating a configuration of an image processing apparatus according to the present embodiment, and FIG. 2 is a block diagram of functional blocks of the image processing apparatus.

As illustrated in FIG. 1, an image processing apparatus 1 includes a controller 10, an image processor 11, a storage unit 12, a communication unit 13, a display 14, an operation unit 15, and a reader 16.

The following descriptions related to the image processing apparatus 1 and the operation thereof are provided based on assumption that the image processing apparatus 1 is configured by a single computer. However, the image processing apparatus 1 may be configured by a plurality of computers in such a manner that the processing is distributed.

The controller 10 realizes various functions by controlling the components of the apparatus using a processor such as a CPU (Central Processing Unit), a memory, and the like.

The image processor 11 performs image processing in response to a control instruction from the controller 10 by using a processor such as a GPU (Graphics Processing Unit) and a dedicated circuit and a memory. The controller 10 and the image processor 11 may be an integrated hardware part. The controller 10 and the image processor 11 may be configured as single hardware (SoC: System On a Chip) in which the processors such as a CPU and a GPU, the memory, the storage unit 12, and the communication unit 13 are integrated together.

The storage unit 12 uses a hard disk or a flash memory and a RAM (Random Access Memory). The storage unit 12 stores therein an image processing program 1P and a machine learning library 121L. The storage unit 12 also stores therein definition data defining a discriminator 42 and a generator 43 that are learning models created for each learning, parameter information of the trained discriminator 42 and the trained generator 43, and the like.

The definition data is information indicating, for example, a network configuration (a layer configuration) of a neural network. The parameter information is information indicating weights of nodes in the neural network.

In the following descriptions, parameters such as the weights of nodes in the neural network are referred to as “NN parameters”. One or more parameters such as a reduction ratio and a pixel variation amount in degradation processing on an image are described as one or more “degradation processing parameters” and distinguished from the NN parameters described above.

The storage unit 12 can store therein target image data that is a target of super-resolution processing (that serves as a seed of image generation), output image data that is the result of super-resolution processing, training image data for training the discriminator 42 and the generator 43, processed image data obtained by processing the training image data, and the like.

The learning model defined by the definition data and the NN parameters is included in the machine learning library 121L, and the machine learning library 121L is executed by the controller 10, whereby the image processor 11 realizes the discriminator 42 and the generator 43 that perform learning and inference in the present embodiment.

The discriminator 42 that is a first machine learning model outputs, based on image data input thereto, one or more tag values each indicating the degree of blur of the image data. The discriminator 42 may be trained so as to be able to be used alone.

The generator 43 that is a second machine learning model can be configured by an appropriate combination of networks such as a transposed convolution layer, a convolution layer, and up-sampling. The trained generator 43 generates image data (obtained by up-sampling) from data as a seed input thereto and the one or more tag values described above, and outputs the generated image data.

The machine learning library 121L has an inference engine (program) that performs learning and inference and, when the definition data and the NN parameters are given thereto, executes the engine. Accordingly, the definition data and the NN parameters have functions as a machine learning model.

Although typical examples of the machine learning library 121L include TensorFlow and Cafe, the machine learning library 121L is not limited thereto and any machine learning library may be used.

In a case where the discriminator 42 is configured by a machine learning model only and target image data input to the generator 43 is not divided into blocks, the discriminator 42 and the generator 43 may be integrated together.

In the present embodiment, only the machine learning library 121L is described as a machine learning library that realizes the discriminator 42 and the generator 43. However, a discriminator library realizing the discriminator 42 and a generator library realizing the generator 43 may be provided separately from each other. In this case, the machine learning library 121L provides functions as a machine learning model, and the discriminator library and the generator library provide, for example, definition data such as a layer configuration and parameters such as weights of respective nodes in the machine learning model.

The communication unit 13 is a communication module that realizes connection of communication to a communication network such as the Internet. The communication unit 13 uses a network card, a wireless communication device, or a module for carrier communication.

The display 14 uses a liquid display panel or an organic EL (Electro Luminescence) display, for example. The display 14 can display an image by processing in the image processor 11 performed in response to an instruction from the controller 10.

The operation unit 15 includes a user interface such as a keyboard and a mouse. Physical buttons provided in a housing may be used. In addition, software buttons or the like displayed on the display 14 may be used. The operation unit 15 notifies the controller 10 of information on an operation by a user.

The reader 16 uses, for example, a disk drive and can read an image processing program 2P and a machine learning library 21L that are stored in a recording medium 2 using an optical disk or the like. The image processing program 1P and the machine learning library 121L stored in the storage unit 12 may be duplication of the image processing program 2P and the machine learning library 21L read from the recording medium 2 by means of the reader 16, the duplication being made by the controller 10 into the storage unit 12.

The controller 10 of the image processing apparatus 1 serves as a learning processing execution unit 31 and an image processing execution unit (an inference processing controller) 32 based on the image processing program 1P stored in the storage unit 12.

The image processor 11 serves as the discriminator 42 using a memory based on the machine learning library 121L, the definition data, and the parameter information stored in the storage unit 12.

The image processor 11 also serves as the generator 43 using a memory based on the machine learning library 121L, the definition data, and the parameter information stored in the storage unit 12.

Further, the image processor 11 serves as an input unit 41 and an output unit 44 for performing image input and image output to or from the discriminator 42 and the generator 43. Functions of the input unit 41 and the output unit 44 may be included in each of the discriminator 42 and the generator 43, or in the learning processing execution unit 31 and the image processing execution unit 32 executed by the controller 10.

Furthermore, the image processor 11 serves as a processing unit 45 that processes training image data and a cropping unit 46 that crops the training image data. Functions of the processing unit 45 and the cropping unit 46 may be included in the learning processing execution unit 31 and the image processing execution unit 32 executed by the controller 10.

In FIG. 2, the machine learning library 121L is not illustrated in the storage unit 12 because the functions of the discriminator 42 and the generator 43 are realized by the machine learning library 121L.

The learning processing execution unit 31 performs processing of causing the machine learning model to learn the NN parameters of the discriminator 42 based on the machine learning library 121L and training image data so as to cause the machine learning model to serve as the discriminator 42.

The learning processing execution unit 31 also performs processing of causing the machine learning model to learn the NN parameters of the generator 43 based on the machine learning library 121L and the training image data so as to cause the machine learning model to serve as the generator 43.

The image processing execution unit 32 executes processing of inputting image data to the trained discriminator 42 and acquiring a result output from the discriminator 42.

The image processing execution unit 32 also executes processing of inputting image data as a seed to the trained generator 43 and acquiring image data generated by the generator 43.

The image processing execution unit 32 may draw an image from the image data output from the generator 43 and cause the display 14 to output that image.

The image processing apparatus 1 may be provided with a machine learning model as a classifier (discriminator) that configures GAN (Generative Adversarial Networks) for training the generator 43, in addition to the machine learning model as the discriminator 42 and the generator 43.

In this case, the image processing apparatus 1 may include a classifier library in the storage unit 12 and store definition data defining the classifier and NN parameters.

The image processing execution unit 32 performs processing of causing the machine learning model to learn the NN parameters based on the machine learning library 121L, the classifier library, and training image data so as to cause the machine learning model to serve as the classifier.

The image processing execution unit 32 provides image data to the trained classifier and acquires a result output from the classifier. The trained classifier classifies image data input thereto into image data generated by the generator 43 and other image data based on a feature extracted from the image data input thereto.

The classifier is configured to include convolution layers in a plurality of stages defined by parameters that are to be learned. The configuration of the classifier is not limited thereto, and may include a pooling layer, a fully-connected layer, or the like. The discriminator of present embodiment is described.

FIG. 3 is a conceptual diagram for explaining learning by the discriminator according to the present embodiment.

Learning by the discriminator is performed under control of the learning processing execution unit 31.

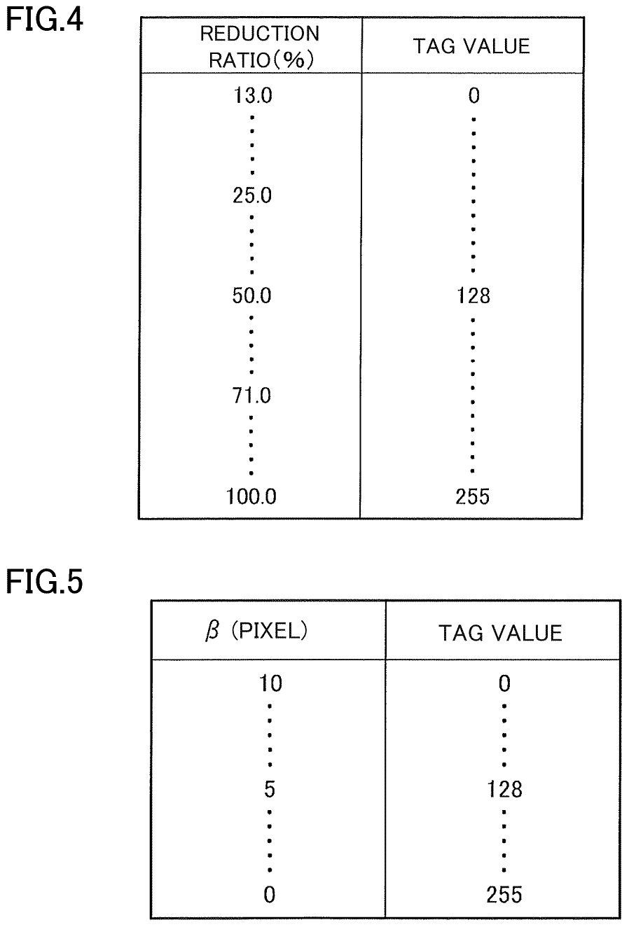

The learning processing execution unit 31 inputs training data to the processing unit 45 and cause the processing unit 45 to perform degradation processing (e.g., reduction and Gaussian blur) based on one or more degradation processing parameters (e.g., a reduction ratio and a pixel variation amount) represented in FIGS. 4 to 6 described later, on the training image data to generate processed image data.

The learning processing execution unit 31 causes the processed image data thus generated to be input to the discriminator 42, thereby causing the discriminator 42 to perform learning. This learning is learning of NN parameters for enabling the discriminator 42 to output one or more values each indicating the degree of blur in target image data when the target image data is input to the discriminator 42.

For example, the learning processing execution unit 31 causes the machine learning model to learn the NN parameters in such a manner that the processed image data obtained by reduction of the training image data by 71% with the degradation processing parameter set to a reduction ratio of 71% is input to the discriminator 42, and the discriminator 42 outputs a tag value corresponding to 71% that is the degradation processing parameter.

In this learning, the learning processing execution unit 31 changes the one or more degradation processing parameters such as a reduction ratio and a pixel variation amount in various ways in accordance with tables in FIGS. 4 to 6 described below, thereby generating one or more pieces of processed image data.

The learning processing execution unit 31 inputs the one or more pieces of processed image data thus generated to the discriminator 42 to cause the discriminator 42 to perform learning.

Only a numerical value indicating the percentage of the size of an original image (a reduction ratio) may be input, instead of performing actual size reduction of the training image data.

The learning processing execution unit 31 causes the discriminator 42 to output one or more tag values corresponding to the respective pieces of processed image data and compares the output tag values and each tag value corresponding to the degradation processing parameter used in generation of each piece of processed image data.

Examples of the tag value to be output here are a tag value of 128 regarding a reduction ratio when reduction by 50% is performed, a tag value of 128 regarding Gaussian blur when Gaussian blur with a pixel variation amount of 5 represented in FIG. 5 is also performed, or a tag value of 96 regarding the combination of a reduction ratio of 50% and a pixel variation amount of 5.

When all the output tag values and the tag values corresponding to the degradation processing parameters used in generation of the processed image data do not match each other, the learning processing execution unit 31 repeats adjustment of the NN parameters and output of the tag values until all the tag values output from the discriminator 42 and the tag values corresponding to the degradation processing parameters match each other. The NN parameters when all of them match each other become the NN parameters of the trained discriminator 42.

The discriminator 42 trained in this manner can output, when any image data is input thereto, one or more tag values in accordance with the degree of blur included in that image data.

FIGS. 4 to 6 are diagrams illustrating tables in which tag values each indicating the degree of blur are assigned to the degree of degradation processing. In particular, 256 tag values from 0 to 255 indicating the degree of blur are assigned to the degree of degradation processing. In this example, the degree of blur is smaller as the tag value is larger.

FIG. 4 illustrates a table that defines the relation between a reduction ratio and a tag value indicating the degree of blur. For example, the tag value is defined in advance so as to change with a change in reduction ratio as represented in FIG. 4. It is assumed that a tag value for a reduction ratio of 13% is 0, a tag value for a reduction ratio of 50.0% is 128, and a tag value for a reduction ratio of 100% is 255, for example.

The learning processing execution unit 31 causes a machine learning model to learn the NN parameters of the discriminator 42 in such a manner that, when any target image data is input, the corresponding tag value defined in FIG. 4 is output in accordance with the degree (a reduction ratio) of degradation processing (reduction) performed on the target image data.

FIG. 5 illustrates a table that defines the relation between a pixel variation amount in Gaussian blur and a tag value indicating the degree of blur. For example, the tag value is defined in advance so as to change with a change in pixel variation amount as represented in FIG. 5. It is assumed that a tag value for a pixel variation amount of 10 pixels is 0, a tag value for a pixel variation amount of 5 pixels is 128, and a tag value for a pixel variation amount of 0 pixel is 255, for example.

The learning processing execution unit 31 causes the machine learning model to learn the NN parameters of the discriminator 42 in such a manner that, when any target image data is input, a tag value defined in FIG. 5 is output in accordance with the degree (a pixel variation amount) of degradation processing (Gaussian blur) performed on the target image data.

In the cases of FIGS. 4 and 5, it can be considered that a single type of degradation processing (only reduction or only Gaussian blur) is performed. However, the present embodiment is not limited thereto. A tag value may be output for each of a plurality of types of degradation processing performed in order to obtain processed image data.

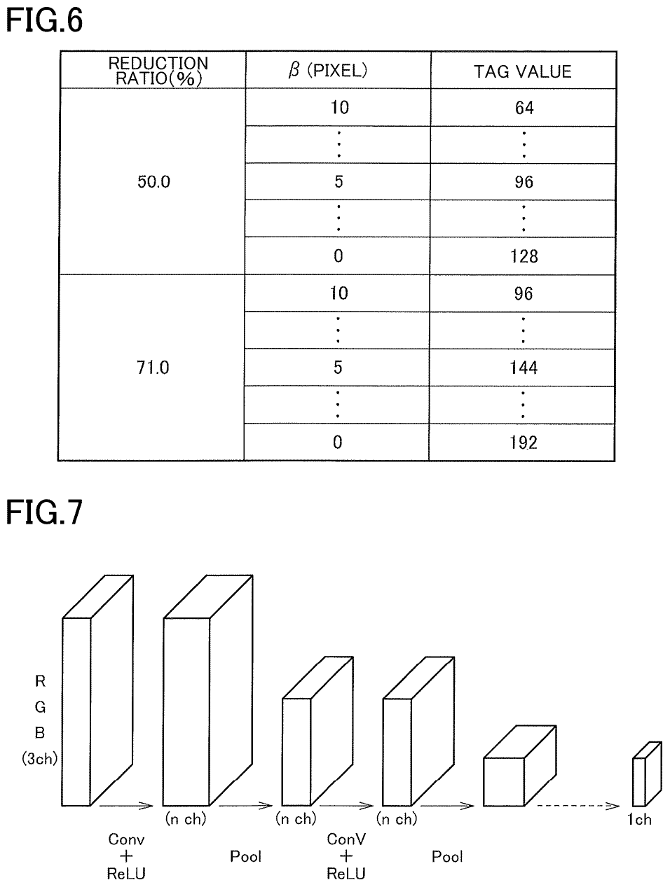

FIG. 6 represents an integrated tag value for a reduction ratio and Gaussian blur.

Instead of setting a tag value for each type of degradation processing as represented in FIGS. 4 and 5, performing a plurality of types of degradation processing may be expected, and one tag value indicating the degree of blur corresponding to a plurality of degradation processing parameters may be set.

The tag value indicating the degree of blur is defined in advance so as to change with a change in reduction ratio and a change in pixel variation amount as represented in FIG. 6. In more detail, the tag value is set to change with a change in pixel variation amount at a certain reduction ratio and to change with a change in pixel variation amount at a different reduction ratio.

For example, a tag value for a reduction ratio of 50.0% and a pixel variation amount of 10 pixels is set to 64, a tag value for a reduction ratio of 50.0% and a pixel variation amount of 5 pixels is set to 96, and a tag value for a reduction ratio of 50.0% and a pixel variation amount of 0 pixel is set to 128.

Further, a tag value for a reduction ratio of 71.0% and a pixel variation amount of 10 pixels is set to 96, a tag value for a reduction ratio of 71.0% and a pixel variation amount of 5 pixels is set to 144, and a tag value for a reduction ratio of 71.0% and a pixel variation amount of 0 pixel is set to 192.

The learning processing execution unit 31 causes the discriminator 42 to learn the NN parameters of the discriminator 42 in such a manner that, when any target image data is input, the corresponding tag value defined in FIG. 6 is output in accordance with the degree (a reduction ratio and a pixel variation amount) of degradation processing (reduction and Gaussian blur) performed on the target image data.

Also, regarding another type of degradation processing such as noise addition and JPEG compression, the learning processing execution unit 31 similarly performs learning by the discriminator in such a manner that a tag value indicating the degree of blur corresponding to the degree of degradation is output.

FIG. 7 is a conceptual diagram for explaining how to derive a tag value in a discriminator of the present embodiment.

The discriminator 42 receives, as input, processed image data in learning or target image data in inference and repeats convolution, an activation function process, a pooling process, and the like, thereby finally outputting one piece of data (a tag value). This process of the discriminator 42 is similar to a process of inputting RGB image data to obtain grayscale data for one pixel.

The number of output channels can be changed in accordance with the type of degradation processing. For example, in a case of using, as a tag value, a reduction ratio only or a pixel variation amount only, the number of output channels is one. In this case, when an image at a reduction ratio of 50.0%, for example, is input to the trained discriminator 42 and subjected to processing, the discriminator 42 outputs a tag value indicating the degree of blur corresponding to the reduction ratio of 50%.

The discriminator 42 can also be configured to learn tag values regarding both the reduction ratio and Gaussian blur and obtain two-channel output (output of two tag values) in inference.

### Generator

Next, the generator of present embodiment is described.

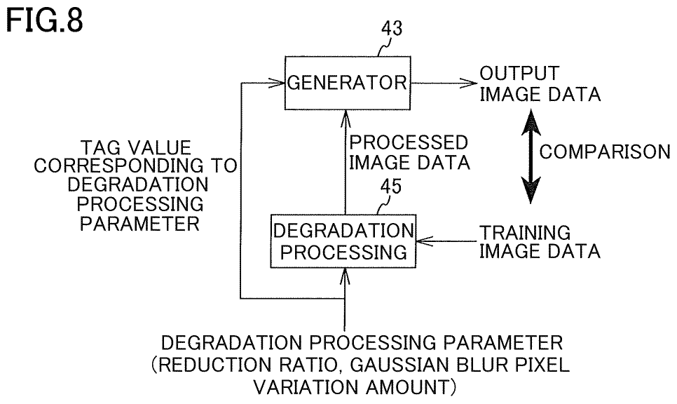

FIG. 8 is a conceptual diagram for explaining learning by the generator in the present embodiment.

Learning by the generator is performed under control of the learning processing execution unit 31.

As illustrated in FIG. 8, the learning processing execution unit 31 inputs training image data to the processing unit 45 and cause the processing unit 45 to perform degradation processing (e.g., reduction and Gaussian blur) based on one or more degradation processing parameters such as a reduction ratio and a pixel variation amount defined in FIGS. 4 to 6 on the training image data to obtain processed image data.

For example, the learning processing execution unit 31 reduces the size of training image data at a certain reduction ratio (1/4 when the training image data is used for super-resolution at a four times magnification) and blurs the data after reduction in accordance with a numerical value indicating the degree of blur caused by Gaussian blur or the like, thereby generating processed image data.

The learning processing execution unit 31 changes the one or more degradation processing parameters, such as a reduction ratio and a pixel variation amount in various ways in accordance with the tables in FIGS. 4 to 6 described above, thereby generating one or more pieces of processed image data. Processed image data generated for learning by the discriminator 42 may be used as the processed image data used for learning by the generator.

The learning processing execution unit 31 inputs the one or more pieces of processed image data thus generated and one or more tag values corresponding to the one or more degradation processing parameters used for generation of these pieces of processed image data to the generator 43 to cause the generator 43 to perform learning.

Examples of these tag values include a tag value of 128 regarding a reduction ratio when reduction by 50% represented in FIG. 4 is performed as degradation processing, a tag value of 128 regarding Gaussian blur when Gaussian blur with a pixel variation amount of 5 represented in FIG. 5 is also performed, or a tag value of 96 regarding the combination of a reduction ratio of 50% and a pixel variation amount of 5.

This learning is learning of NN parameters for enabling the discriminator 42 to output information (one or more tag values) indicating the degree of blur in an image based on target image data and the degree of blur indicated by a tag value when the target image data is input.

The learning processing execution unit 31 inputs the processed image data and the one or more tag values to the generator 43 and causes the generator 43 to generate an image. The learning processing execution unit 31 inputs, for example, processed image data obtained by performing reduction at a reduction ratio of 50% (degradation processing) on training image data and a tag value indicating the degree of blur corresponding to a reduction ratio of 50% to the generator 43. Since information indicating a reduction ratio of 50% is input to the generator 43, the generator 43 outputs output image data having the size twice the size of an input image as a result of processing.

The learning processing execution unit 31 compares generated images and the training image data (the size of 100%) with each other. When both images do not all match each other as a result of comparison, adjustment of NN parameters and image generation are repeated until both images match (come closer to) each other. The NN parameters when both match each other become the NN parameters of the trained generator 43.

In learning by the generator 43 by the learning processing execution unit 31, a classification result (a result of determination of true or false performed on training data) by the above-described classifier can be used, for example.

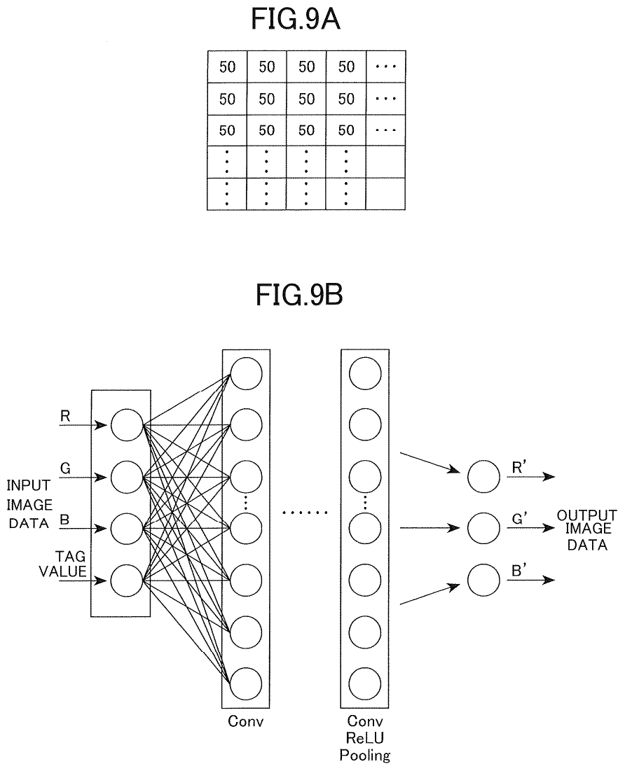

FIGS. 9A and 9B are diagrams for explaining a tag value input to a generator of the present embodiment.

It is assumed that a tag value input to the generator 43 in learning or inference is two-dimensional according to an input image (processed image data in learning or target image data in inference).

For example, when a tag value is “50” as represented in FIG. 9A, the tag value of the same pixel is prepared for the number of pixels of an input image. These prepared tag values are input to the generator 43 as one piece of data.

As illustrated in FIG. 9B, the learning processing execution unit 31 inputs a tag value of one channel or tag values of a plurality of channels acquired and R data, G data, and B data (three channels including R, G, and B) of processed image data to the generator 43 and obtains output image data by machine learning. The generator 43 performs a convolution process in a convolution layer (Conv), an activation process in an activation layer (RoLU), and a pooling process in a pooling layer (Pooling) repeatedly while performing the convolution process at first, thereby generating R data, G data, and B data (three channels of R′, G′, and B′) different from the input image data. Finally, the generator 43 combines these R data, G data, and B data together to obtain output image data. This description also applies to Gaussian blur, JPEG compression, and noise addition.

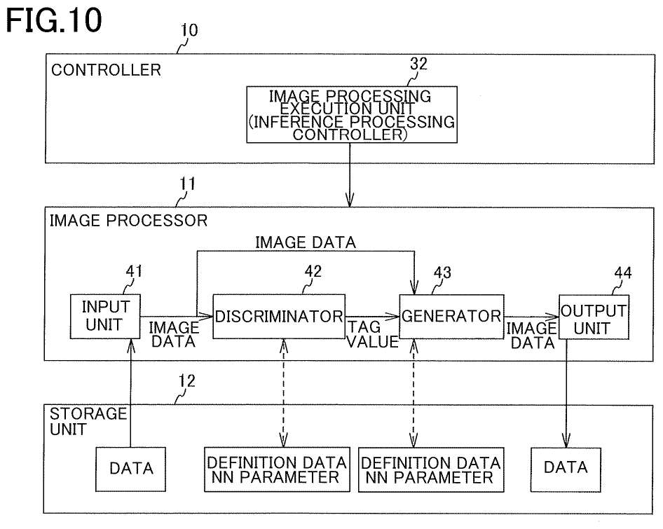

FIG. 10 is a diagram for explaining image generation processing executed by an image processing apparatus.

Image generation processing is performed under control of the image processing execution unit 32.

The input unit 41 acquires target image data stored in the storage unit 12 and inputs the acquired target image data to the discriminator 42.

The discriminator 42 performs inference on the target image data by using definition data and NN parameters stored in the storage unit 12 and outputs a tag value.

The input unit 41 further inputs the target image data to the generator 43.

The generator 43 performs image generation using the target image data as a seed by using the tag value output from the discriminator 42, the target image data, and the definition data and the NN parameters stored in the storage unit 12 to generate output image data.

The output unit 44 outputs the output image data generated by the generator 43 to the storage unit 12.

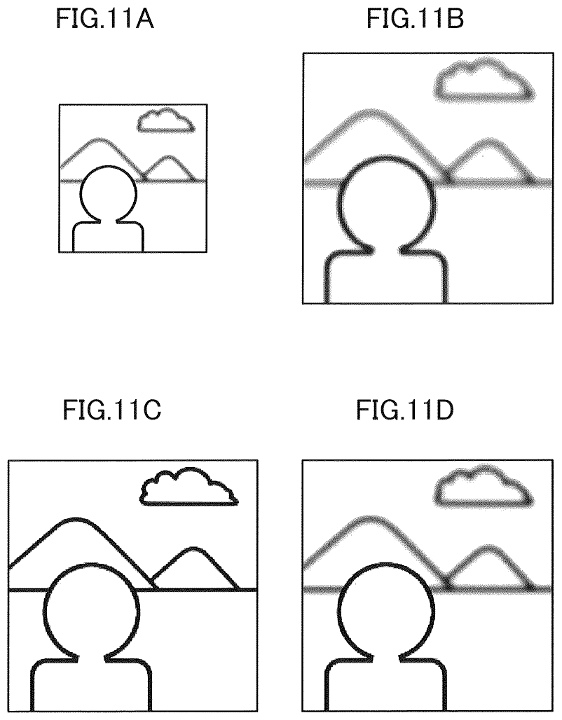

FIGS. 11A to 11D are diagrams for explaining an image generated by the image processing apparatus according to the present embodiment. FIG. 11A illustrates target image data serving as a seed, FIG. 11B illustrates a state where the entire image is out of focus, FIG. 11C illustrates a state where the entire image is sharpened, and FIG. 11D illustrates a state where, in accordance with the depth of field, the foreground is sharpened and the background is blurred.

The image as a seed is a low-resolution image in which the person in the foreground is in focus whereas the background scenery is blurred because of the depth of field.

In a case where the low-resolution image is simply enlarged, the entire image becomes blurred as illustrated in FIG. 11B. According to the conventional technique described in Real-ESRGAN: Training Real-World Blind Super-Resolution with Pure Synthetic Data, both the person in the foreground and the background are sharpened as illustrated in FIG. 11C, so that an image different from the original image is obtained. Meanwhile, the image processing apparatus of the present embodiment can sharpen only the person in the foreground while keeping the background, which is blurred in the original image, blurred as illustrated in FIG. 11D.

That is, the image processing apparatus 1 of the present embodiment can realize super-resolution with a feature of the entire low-resolution image in FIG. 11A captured as it is.

As described above, a super-resolution model such as Real-ESRGAN: Training Real-World Blind Super-Resolution with Pure Synthetic Data, has a problem that when a high-resolution image is generated (reproduced) based on image data as a seed, an image different from the original image is generated because all the blur below a certain level is sharpened.

Meanwhile, the image processing apparatus 1 of the present embodiment, when generating (reproducing) a high-resolution image based on image data as a seed, explicitly provides information on the degree of blur of the target image data as a seed to the generator 43. Accordingly, the generator 43 can also reproduce the blur of the target image data when reproducing the high-resolution image.

Therefore, the background or the like that has been blurred is not sharpened, and the resolution of a portion that has not been blurred is increased as it is. Consequently, the resolution can be increased while keeping the original image.

Further, regarding the problem that the blurred image is entirely sharpened and becomes different from the original image, it is not necessary to prepare, in a pair of processed image data and training image data for the generator 43, a pattern of sharpening a blurred image and a pattern of keeping a blurred image blurred, and decrease in learning efficiency can be prevented.

### First Modification

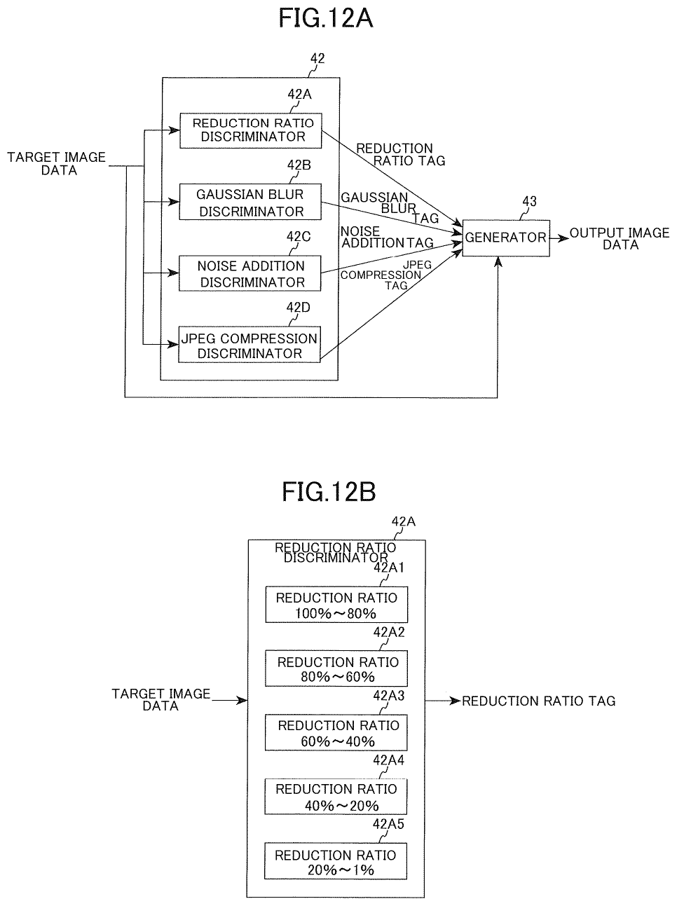

FIGS. 12A and 12B are diagrams illustrating a first modification of the discriminator of the present embodiment.

As illustrated in FIG. 12A, the image processing apparatus of the present embodiment may include a discriminator for each type of degradation processing.

For example, the image processing apparatus 1 may include a reduction ratio discriminator 42A, a Gaussian blur discriminator 42B, a noise addition discriminator 42C, and a JPEG compression discriminator 42D. In this case, the discriminators 42A to 42D perform learning regarding tag values each indicating the degree of blur in accordance with the type of degradation processing in processed image data (a reduction ratio tag value, a Gaussian blur tag value, a noise addition tag value, and a JPEG compression tag value), respectively.

The discriminators 42A to 42D may be configured in such a manner that, in inference, they output tag values each indicating the degree of blur for a corresponding factor in target image data and the tag values output from the discriminators 42A to 42D are input to the generator 43.

In a case where only reduction is performed on processed image data, a tag value in accordance with a reduction ratio (a reduction ration tag value) is output from the reduction ratio discriminator 42A, and tag values in a case where no degradation processing is performed (255 in the example in FIG. 5) are output from the other discriminators 42B to 42D. The tag values output from the respective discriminators 42A to 42D are input to the generator 43 and used for learning and inference that are identical to those in the above descriptions.

The discriminator 42 may be divided into further smaller parts. A single model corresponding to numerical values of all the degrees of blur may be set, or the numerical values may be divided into multiple groups based on the magnitude of the numerical value (a reduction ratio), for example, 100% to 80%, 80% to 60%, . . . , and multiple models for the multiple groups of the numerical values may be prepared. In that case, the reduction ratio discriminator 42A in FIG. 12A is configured as a discriminator for each group of reduction ratios, and image data is input to each discriminator. The accuracy of discrimination of a reduction ratio can thus be increased.

For example, as illustrated in FIG. 12B, the reduction ratio discriminator 42A in FIG. 12A is divided into a first reduction ratio discriminator 42A1, a second reduction ratio discriminator 42A2, a third reduction ratio discriminator 42A3, a fourth reduction ratio discriminator 42A4, and a fifth reduction ratio discriminator 42A5.

The first reduction ratio discriminator 42A1 learns a tag value based on processed image data for a reduction ratio of 100% to 80%.

The second reduction ratio discriminator 42A2 learns a tag value based on processed image data for a reduction ratio of 80% to 60%.

The third reduction ratio discriminator 42A3 learns a tag value based on processed image data for a reduction ratio of 60% to 40%.

The fourth reduction ratio discriminator 42A4 learns a tag value based on processed image data for a reduction ratio of 40% to 20%.

The fifth reduction ratio discriminator 42A5 learns a tag value based on processed image data for a reduction ratio of 20% to 0%.

The trained first to fifth reduction ratio discriminators 42A1 to 42A5 can output a reduction ratio tag value from target image data of super-resolution more accurately when inference is performed.

### Second Modification

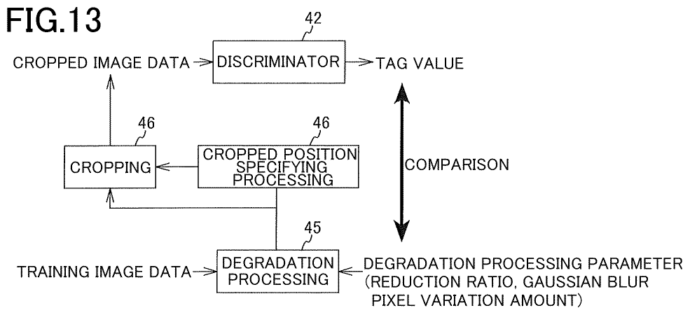

FIG. 13 is a diagram illustrating a second modification of the discriminator of the present embodiment.

In the descriptions of the above embodiment, entire processed image data has been input to the discriminator 42 when the discriminator 42 performs learning. As in the case of learning, the entire processed image data is input to the discriminator 42 when the discriminator 42 performs inference during image generation processing.

In this modification, the image processing apparatus 1 inputs a specific portion of processed image data cropped by the cropping unit 46 executed by the image processor 11 to the discriminator 42 and causes the discriminator 42 to perform learning and inference, thereby reducing computation load in learning and inference.

For example, blur is caused by degradation applied to the entire image, for example, enlargement of a small image or application of image compression such as JPEG. A state where a portion of an image is largely degraded whereas another portion is less degraded does not occur basically. It is expected that the same degradation occurs in one image.

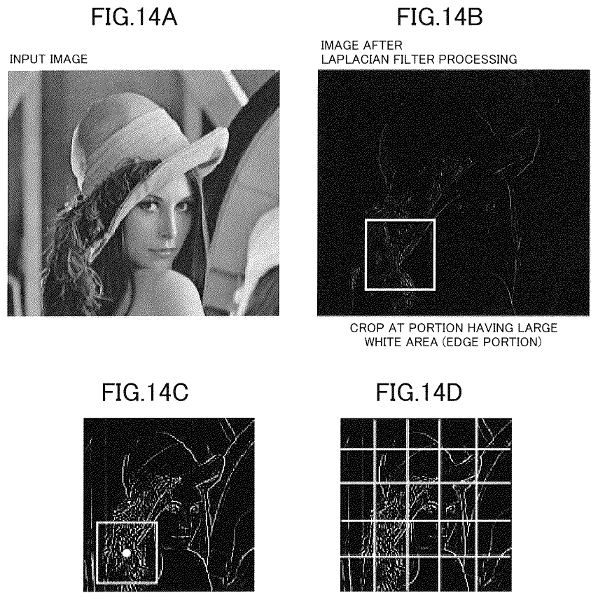

Further, it is highly likely that the most complicated portion in one image (e.g., the hair of the person in the foreground illustrated in FIG. 14A) is originally unblurred. It is considered that as a result of degradation processing, degradation in that portion is also applied to the entire image in the same manner.

The cropping unit 46 crops the most complicated portion in an image and inputs the cropped portion to the trained discriminator 42, and thus it can be detected how much the image is blurred. Consequently, it is not necessary to input the entire image to the discriminator 42 and cause the discriminator 42 to perform learning and inference, so that computation load can be reduced.

Regarding the generator 43, there is a tendency that in a case of using GAN, the entire image is sharpened even if the generator 43 is trained by using a tag value indicating the degree of blur. However, this configuration can serve as the countermeasure of this problem.

The image processing apparatus 1 identifies the most complicated portion in an image by the method described below, crops the identified portion, and uses the cropped portion for learning and inference in the discriminator 42.

FIGS. 14A to 14D are diagrams for explaining a method of identifying the most complicated portion in an image as a cropped position in the image. Known image processing can be used for this identification.

For example, a method is considered which roughly identifies a portion in which pixels are arranged in a complicated manner in an image by using a gradient filter, an edge detection filter, or the like and puts that portion to a discriminator.

The image processing apparatus 1 performs processing using the Laplacian filter on a processed image (input image) as illustrated in FIG. 14A to obtain an image after filter processing as illustrated in FIG. 14B.

The portion identified as the position at which cropping is to be performed is different depending on the type of degradation processing. In a case where degradation processing is any of reduction, Gaussian blur, and JPEG compression, the image processing apparatus 1 crops the processed image in FIG. 14A at a position corresponding to a portion having a large white area in the image after filter processing in FIG. 14B. A white area means an edge portion, and the large white area is an area where a large value is detected. In the image after filter processing, the portion having a large white area is a portion in which a change between pixels is large. For example, the position of cropping is desirably around a pixel having the largest white area, in which the change between pixels is the largest or a value obtained by the Laplacian filter is the largest.

As a method of identifying a portion including the most complicated image after filter processing, as illustrated in FIG. 14C, it is possible to identify only a portion around a pixel at which a large value is detected with a specific size. Alternatively, as illustrated in FIG. 14D, it is possible to divide the image in FIG. 14B into blocks and identify the block including the largest numerical value as the portion including the most complicated image. Alternatively, the block at such a position that the total of values in the block is the largest may be identified as the specific portion.

In a case where the type of degradation processing is noise addition, the position of a portion in which a change between pixels is the smallest (the value obtained by the Laplacian filter processing is the smallest) in the processed image data is identified. Alternatively, the block at such a position that the total of values in the block is the smallest may be identified as the specific portion. For example, in a case of noise that is put on the entire image, such as film-grain noise, the amount of noise put on the image can be estimated from the amount of noise in a flat portion having the least complicated image, contrary to the case of blur. Further, regarding noise associated with JPEG compression, it can be considered that the nature of noise is close to that of blur because that noise is degradation of an original image. Therefore, it is considered that determination is desirably performed based on the portion in which the change between pixels is large, as with blur. In a case of JPEG, the compression quality is estimated.

However, in a case of using noise as degradation processing, there are various noise addition methods, and degradation processing parameters are different from each other. Therefore, it is difficult to describe those methods and parameters as a whole.

In a case of Real-ESRGAN described above, two noise distribution functions and a parameter determining the shape of each function (e.g., a standard deviation) are set, and there is a condition whether noise is added to all of R, G, and B or is added individually.

Since the present embodiment captures a feature applied to the entire image, it is preferable that the type of noise is a type that uniformly occurs in the entire image. Use of the Gaussian distribution or even distribution is considered as a method of adding uniform noise to the entire image. In this case, it suffices that the correspondence with tag values as represented in FIGS. 4 to 6 is set in such a manner that the tag value is 0 when the amount of noise addition is the largest value.

Further, in a case of handling a plurality of types of noise, it is preferable to prepare a discriminator for each type of noise and cause to the discriminator and a generator to perform learning, as in the case of a reduction ratio in FIG. 12B.

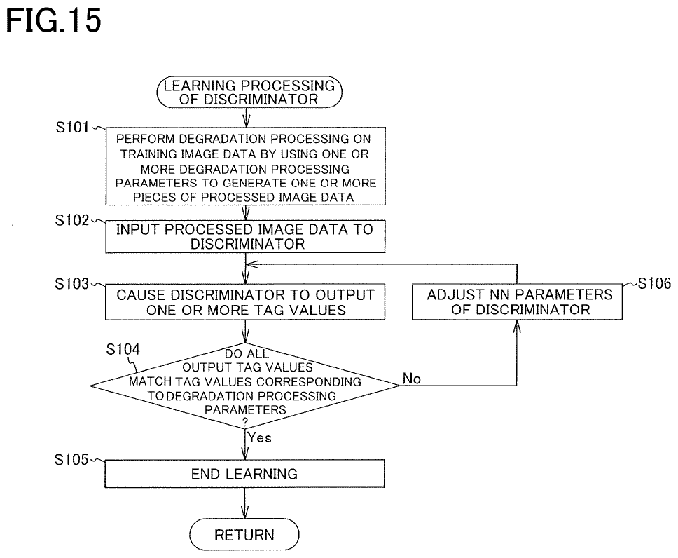

FIG. 15 is a flowchart for explaining learning processing of the discriminator in the present embodiment.

At Step S101, the image processing apparatus 1 (the learning processing execution unit 31) causes the processing unit 45 to perform degradation processing based on one or more degradation processing parameters on training image data to generate one or more pieces of processed image data.

At Step S102, the image processing apparatus 1 (the learning processing execution unit 31) inputs the processed image data to the discriminator 42.

At Step S103, the image processing apparatus 1 (the learning processing execution unit 31) causes the discriminator 42 to output one or more tag values.

At Step S104, the image processing apparatus 1 (the learning processing execution unit 31) determines whether all the output tag values match tag values corresponding to the degradation processing parameters.

When it is determined that they do not match each other (No at Step S104), the image processing apparatus 1 (the learning processing execution unit 31) changes NN parameters of the discriminator 42 at Step S106, causes the discriminator 42 to output one or more tag values at Step S103, and performs determination at Step S104.

When it is determined that they match each other (Yes at Step S104), the image processing apparatus 1 (the learning processing execution unit 31) ends the learning processing of the discriminator 42 at Step S105.

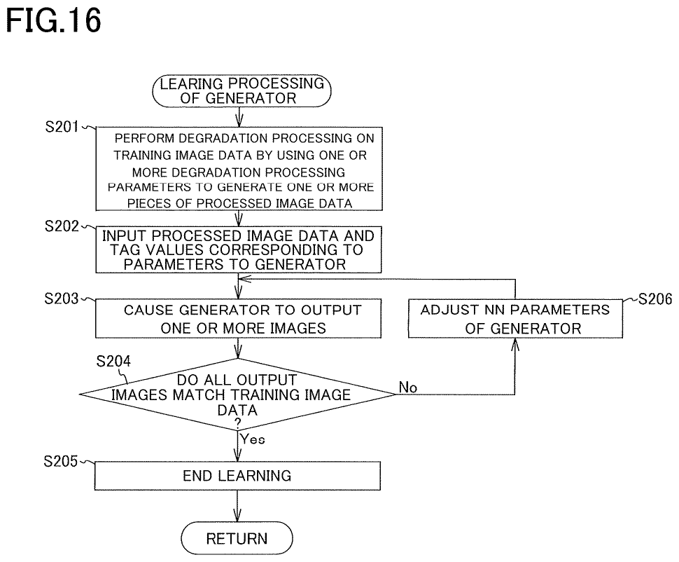

FIG. 16 is a flowchart for explaining learning processing of the generator in the present embodiment.

At Step S201, the image processing apparatus 1 (the learning processing execution unit 31) causes the processing unit 45 to perform degradation processing based on one or more degradation processing parameters on training image data to generate one or more pieces of processed image data.

At Step S202, the image processing apparatus 1 (the learning processing execution unit 31) inputs the processed image data thus generated and one or more tag values corresponding to the degradation processing parameters to the generator 43.

At Step S203, the image processing apparatus 1 (the learning processing execution unit 31) causes the generator 43 to generate one or more images based on the processed image data and the one or more tag values.

At Step S204, the image processing apparatus 1 (the learning processing execution unit 31) determines whether all the images generated at Step S203 match training image data. This determination may be performed based on whether the result of determination by the classifier described above is true.

When it is determined that they do not match each other (No at Step S204), the image processing apparatus 1 (the learning processing execution unit 31) changes NN parameters of the generator 43 at Step S206, causes the generator 43 to output one or more tag values at Step S203, and performs determination at Step S204.

When it is determined that they match each other (Yes at Step S204), the image processing apparatus 1 (the learning processing execution unit 31) ends the learning processing of the generator at Step S205.

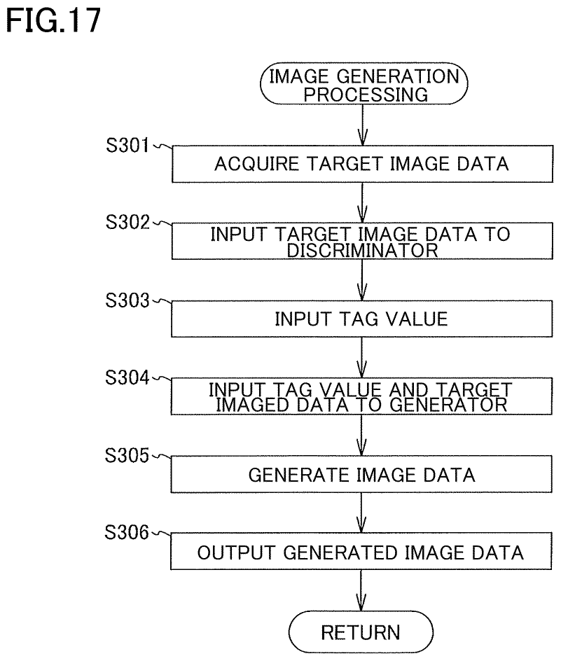

FIG. 17 is a flowchart for explaining image generation processing in the present embodiment.

At Step S301, the image processing apparatus 1 (the image processing execution unit 32) causes the input unit 41 to acquire target image data from the storage unit 12 or the like.

At Step S302, the image processing apparatus 1 (the image processing execution unit 32) causes the acquired target image data to be input to the discriminator 42.

At Step S303, the image processing apparatus 1 (the image processing execution unit 32) causes the discriminator 42 to output one or more tag values based on the target image data.

At Step S304, the image processing apparatus 1 (the image processing execution unit 32) inputs the output tag values and the target image data as a seed to the generator 43.

At Step S306, the image processing apparatus 1 (the image processing execution unit 32) causes the generator 43 to generate output image data based on the one or more tag values and the target image data.

At Step S307, the image processing apparatus 1 (the image processing execution unit 32) causes the output unit 44 to output the output image data generated by the generator 43 to the storage unit 12 or the like.

### Modification of Generator

In the above description, a super-resolution process has been performed for target image data in an appropriate manner by inputting an entire image or the most complicated (unblurred) portion of the image to the discriminator 42 to cause the discriminator 42 to output a tag value indicating the degree of blur, and inputting the tag value to the generator 43.

By inputting the tag value to the generator 43 together with the target image data, the background or the like that has been blurred is not sharpened and the resolution of the unblurred portion is increased as it is. Consequently, the resolution can be increased while an original image is kept as it is.

In recent years, an “Attention” mechanism that identifies closely related data and generates new data is used for various purposes in fields using machine learning. A generator 43A according to a modification can use the “Attention” mechanism in the super-resolution process in addition to the configuration described with regard to the generator 43.

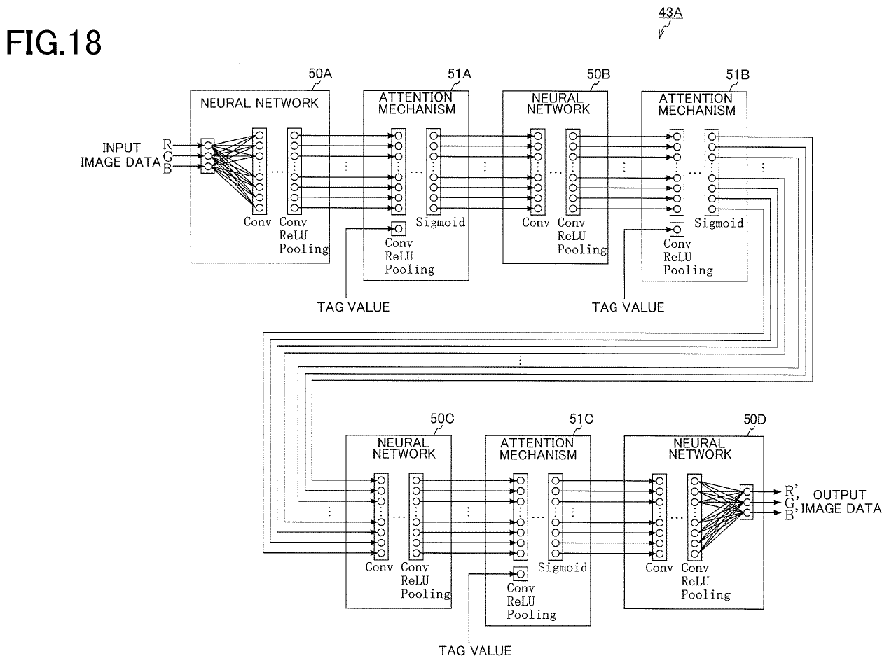

FIG. 18 is an explanatory diagram of a configuration of a generator according to the modification of the present embodiment.

The generator 43A illustrated in FIG. 18 includes neural networks (hereinafter, simply described as “networks”) 50 (50A, 50B, 50C, and 50D) and Attention mechanisms 51 (51A, 51B, and 51C) provided between the networks 50. The Attention mechanisms 51 can also be configured as neural networks, but are distinguished from the networks 50 here.

The generator 43A learns NN parameters of the networks 50 and the Attention mechanisms 51 so as to be able to generate a super-resolution image based on target image data and a tag value by the networks 50 and the Attention mechanisms 51.

The learning procedure of the generator 43A can be identical to the procedure described with reference to FIG. 16 except for the configuration of the neural networks. The image generation procedure of the generator 43A can also be identical to the procedure described with reference to FIG. 17 except for the configuration of the neural networks.

Although the detailed configuration of the Attention mechanisms 51 will be described in detail later, Channel Attention, Spatial Attention, and Dot-Product Attention that are used for image processing can be used, for example. These Attentions may be used in combination by being connected to each other in series or in parallel.

Although the number of networks 50 and the number of Attention mechanisms 51 are not limited to those in the example of FIG. 18, the generator 43 A includes two or more networks 50 and the Attention mechanisms 51 provided between the networks 50.

The network 50A serves as an input stage to which target image data is input and the network 50D serves as an output stage outputting output image data that has been subjected to a super-resolution process.

The networks 50 and the Attention mechanisms 51 can be ResNet (Residual Neural Networks), RNN (Recurrent Neural Networks) or CNN described above, for example.

The network 50A to which target image data has been input performs processes such as convolution (Conv), linear processing (ReLU), and pooling in order to output processed data to the Attention mechanism 51A in the next stage. Each of the networks 50B, 50C, and 50D has identical configuration to that of the network 50A and performs the identical process for input image data from the Attention mechanism 51 in its previous stage.

To the Attention mechanism 51A, the output data from the network 50A and a tag value output from the discriminator 42 are input.

The Attention mechanism 51A performs convolution, linear processing, pooling, a sigmoid function process, and the like for the image data input from the network 50A and outputs image data formed by a plurality of pieces in each of which the tag value is reflected to the network 50B in the next stage. Each of the Attention mechanisms 51B, 51C, and 51D has identical configuration to that of the Attention mechanism 51A and processes image data input from the network 50 in its previous stage in an identical manner.

Each of the network 50 and the Attention mechanism 51 processes output data from the previous stage repeatedly, and the network 50 in the output stage (the network 50D in this example) finally outputs the output image data.

By using the Attention mechanism 51, in particular, a tag value can be reflected in data or an object that is closely related (meaningful). Therefore, it is possible to generate data in which the degree of blur in an original image is reflected more faithfully. That is, the background or the like that has been blurred is not sharpened and the resolution of an unblurred portion is increased as it is. Consequently, the resolution can be increased while the original image is kept as it is.

The tag value input to the Attention mechanism 51 may be a tag value output by the trained discriminator 42 described with reference to FIG. 3 or 13 based on target image data.

Further, in the generator 43A according to the modification, the Attention mechanism 51 in each stage performs a process of reflecting a tag value in output data from the network 50 in its previous stage. Accordingly, a super-resolution process can be performed more effectively as compared with the case in FIG. 9B in which a tag value is input to the generator 43 together with input image data at one time.

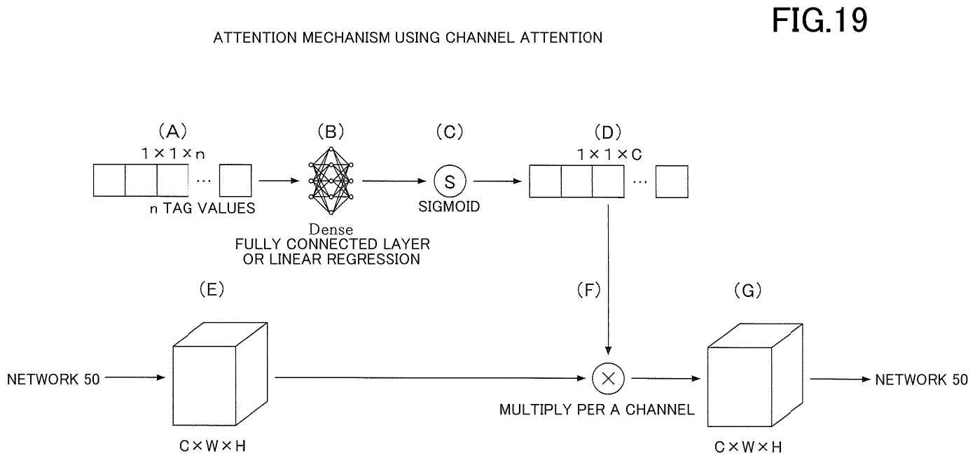

Attention mechanisms applicable to the present embodiment are described below with reference to FIGS. 19 to 21.

In the following descriptions, “C” represents the number of channels of data handled by an Attention mechanism, “W” represents the width (the number of pixels) of image data handled by the Attention mechanism, and “H” represents the height (the number of pixels) of the image data.

In any case, multiplying C×W×H data input from the network 50 by data in which Attention is applied to a tag value can provide new C×W×H image data in which the tag value is reflected. By performing this process after every process by the network 50, as a result of the processing by the generator 43, the background or the like that has been blurred is not sharpened, and the resolution of an unblurred portion is increased as it is. Consequently, the resolution can be increased while an original image is kept as it is.

FIG. 19 is an explanatory diagram of Channel Attention.

In the Attention mechanism using Channel Attention, meaningful data in image data (feature map) input from the network 50 is weighted, and a tag value is applied to the weighted data. Output data in which the degree of blur is reflected more faithfully is thus obtained. The Attention mechanism 51 using Channel Attention performs the following processes in processes of learning and inference of the generator 43A.

The Attention mechanism 51 inputs 1×1×n tag values in (A), where n can be the number of channels of tag values according to the type of degradation processing described with reference to FIG. 7.

The Attention mechanism 51 processes the tag values in Dense (a fully-connected layer or linear regression) in (B) and processes them with a sigmoid function in (C), thereby obtaining 1×1×C data illustrated in (D). The number of channels C may be the number of channels of image data subjected to multiplication in (F) later.

The Attention mechanism 51 inputs image data from the network 50 in the previous stage thereto and performs convolution, linear processing, and pooling, thereby generating C×W×H image data in (E). The Attention mechanism 51 multiplies the data obtained in (D) and the image data obtained in (E) for each channel in (F) to obtain new C×W×H image data in (G).

In a case where convolution and the like are not performed for the image data from the network 50 in the previous stage, the Attention mechanism 51 multiplies the image data (C×W×H) input from the network 50 and the data obtained in (D) for each channel in (F), thereby obtaining new C×W×H image data in (G). The image data obtained in (G) is image data in which tag values are applied to a weighted region of the image data input from the network 50.

The Attention mechanism 51 outputs the new image data to the network 50 in the next stage.

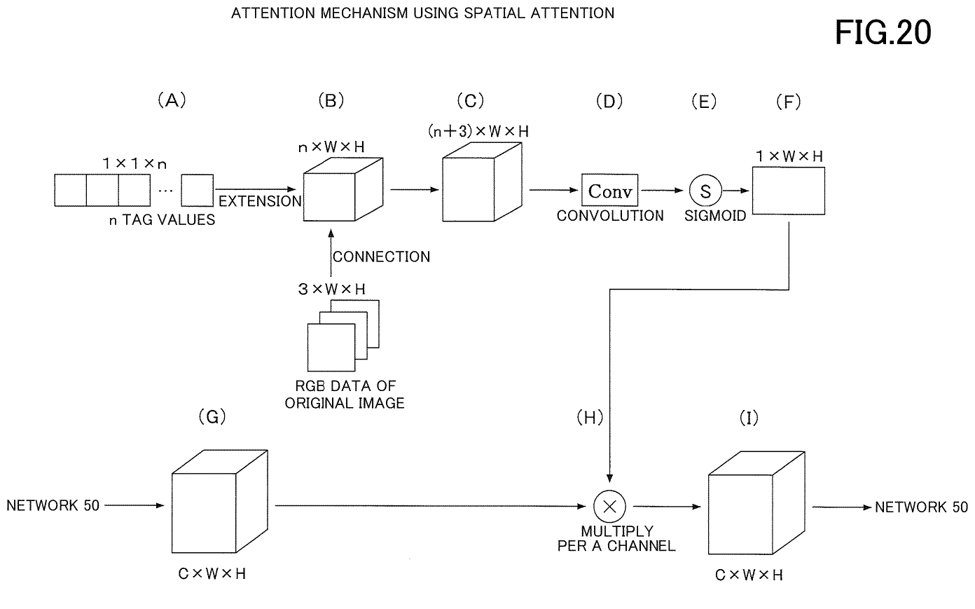

FIG. 20 is an explanatory diagram of Spatial Attention.

The Attention mechanism using Spatial Attention is directed to where an object is located in an image and applies a tag value to such data, thereby obtaining output data in which the degree of blur is reflected more faithfully.

The Attention mechanism 51 using Spatial Attention performs the following processes in learning and inference of the generator 43A.

The Attention mechanism 51 inputs 1×1×n tag values thereto in (A), where n may be the number of channels of tag values according to the type of degradation processing described with reference to FIG. 7.

The Attention mechanism 51 extends the 1×1×n tag values to obtain n×W×H data in (B), where W and H may be the width and height of original image data connected in (C) later.

In (C), the Attention mechanism 51 connects the extended data of tag values obtained in (B) and RGB data (3×W×H) of target image data (original image) to each other by a connecting function to obtain (n+3)×W×H data.

The Attention mechanism 51 performs convolution for the (n+3)×W×H data in (D) and performs a process with a sigmoid function in (E), thereby obtaining 1×W×H data illustrated in (F), where W and H may be the width and height of image data subjected to multiplication in (H) later. The 1×W×H data obtained in (F) is one channel data indicating a tag value at the position of an object included in the original image (target image data).

In (G), the Attention mechanism 51 inputs image data thereto from the network 50 in the previous stage and performs convolution, linear processing, and pooling, thereby generating C×W×H image data. The Attention mechanism 51 multiplies the data obtained in (F) and the image data obtained in (G) for each channel in (H) to obtain new C×W×H image data in (I).

In a case where convolution and the like are not performed for the image data from the network 50 in the previous stage, the Attention mechanism 51 multiplies the image data (C×W×H) input from the network 50 and the data obtained in (F) for each channel in (H), thereby obtaining new CxWxH image data in (I). The image data obtained in (I) is image data in which tag values are applied to a region including the object in the image data input from the network 50.

The Attention mechanism 51 outputs the new image data to the network 50 in the next stage.

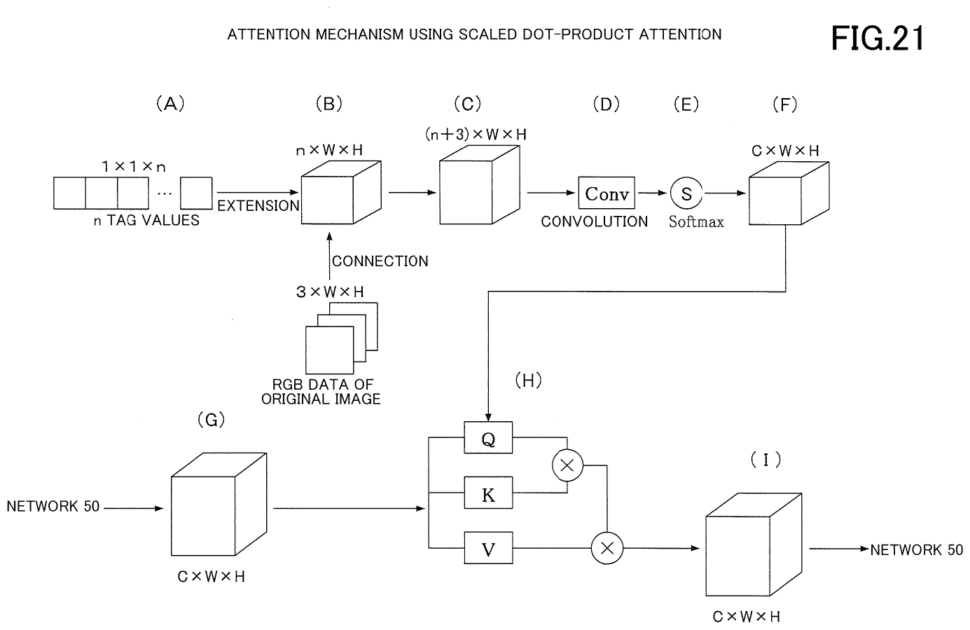

FIG. 21 is an explanatory diagram of Scaled Dot-Product Attention.

The Attention mechanism 51 using Scaled Dot-Product Attention performs the following processes in learning and inference of the generator 43A.

The Attention mechanism 51 inputs 1×1×n tag values thereto in (A), where n may be the number of channels of tag values according to the type of degradation processing described with reference to FIG. 7.

The Attention mechanism 51 extends the 1×1×n tag values to obtain nxWxH data in (B), where W and H may be the width and height of image data connected in (C) later.

In (C), the Attention mechanism 51 connects the n×W×H data in (B) and RGB data (3×W×H) of target image data (original image) to each other by a connecting function to obtain (n+3)×W×H data.

The Attention mechanism 51 performs convolution for the (n+3)×W×H data in (D) and performs a process with a softmax function in (E), thereby obtaining C×W×H data illustrated in (F). Here, C, W, and H can be the number of channels and the width and height of image data used in (H) later. The C×W×H data obtained in (F) is data of the C channels described above indicating tag values at the position of an object included in the original image (target image data).

In (G), the Attention mechanism 51 inputs image data thereto from the network 50 in the previous stage and performs convolution, linear processing, and pooling, thereby generating C×W×H image data.

In (H), the Attention mechanism 51 generates Query, Key, and Value from the image data obtained in (G), inputs the data obtained in (F) to Query to generate Query having the tag value taken into consideration, and multiplies the result of multiplication of Query and Key by Value, thereby obtaining new C×W×H image data in (I).

In the Attention mechanism, Query is a value representing data to be searched in input data. Key is a value used for measuring the closeness of the Query from the data to be searched. Value is data of a result of search based on Key.

By performing the processes in (H), it is possible to apply a tag value to the image data from the network 50 taking the position of an object in the original image (target image data) and the weighting in the image data input from the network 50 into consideration, thereby obtaining the new C×W×H image data in (I).

In a case where convolution and the like are not performed for the image data from the network 50, the Attention mechanism 51 performs the process in (H) that uses the image data input from the network 50 and the data obtained in (F), thereby obtaining new C×W×H data in (I).

The image data obtained in (I) is image data in which the tag values are applied to a region that is weighted (meaningful) and includes an object in the image data input from the network 50.

The Attention mechanism 51 outputs the new image data to the network 50 in the next stage.

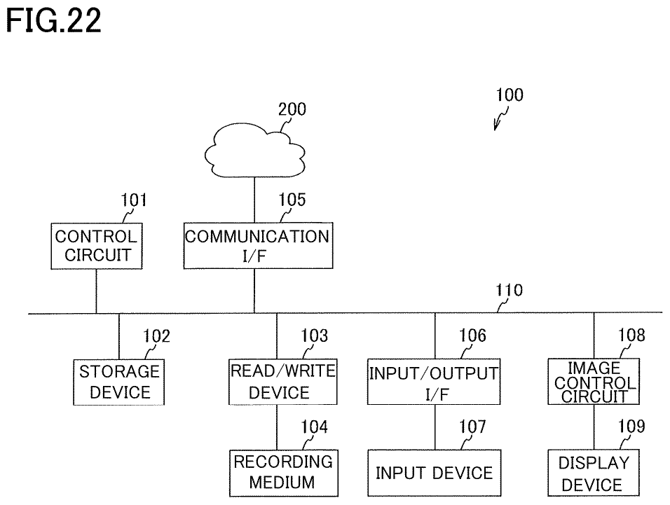

FIG. 22 is a block diagram illustrating an example of a computer apparatus.

A configuration of a computer apparatus 100 is described with reference to FIG. 22.

The computer apparatus 100 is, for example, an image processing apparatus that processes various types of information. The computer apparatus 100 includes a control circuit 101, a storage device 102, a read/write device 103, a recording medium 104, a communication interface 105, an input/output interface 106, an input device 107, and a display device 109.

The communication interface 105 is connected to a network 200. The respective constituent elements are mutually connected to one another via a bus 110. The image processing apparatus 1 can be configured by selecting a part of or all elements from the constituent elements incorporated in the computer apparatus 100 as appropriate.

The control circuit 101 controls the entire computer apparatus 100.

For example, the control circuit 101 is a processor such as a Central Processing Unit (CPU), a Field Programmable Gate Array (FPGA), an Application Specific Integrated Circuit (ASIC), and a Programmable Logic Device (PLD).

The control circuit 101 functions as the controller 10 in FIG. 1, for example.

The image control circuit 108 controls image processing in the computer apparatus 100.

The image control circuit 108 is a Graphic Processing Unit (GPU) and the like. The image control circuit 108 functions as an image processor 11 in FIG. 1.

The storage device 102 stores therein various types of data. For example, the storage device 102 is a memory such as a Read Only Memory (ROM) and a Random Access Memory (RAM), a Hard Disk (HD), a Solid State Drive (SSD), and the like. The storage device 102 may store therein an information processing program that causes the control circuit 101 to function as the controller 10 in FIG. 1. The storage device 102 functions as the storage unit 12 in FIG. 1, for example.

The image processing apparatus 1 loads a program stored in the storage device 102 into a RAM when performing information processing.

The image processing apparatus 1 executes the program loaded to the RAM by the control circuit 101, thereby performing processing that includes at least one of the learning processing execution unit and the image processing execution unit.

The program may be stored in a storage device included in a server on the network 200, as long as the control circuit 101 can access that program via the communication interface 105.

The read/write device 103 is controlled by the control circuit 101, and reads data in the removable recording medium 104 and writes data to the removable recording medium 104.

The recording medium 104 stores therein various types of data. The recording medium 104 stores therein information processing program, for example. For example, the recording medium 104 is a non-volatile memory (non-transitory computer-readable recording medium) such as a Secure Digital (SD) memory card, a Floppy Disk (FD), a Compact Disc (CD), a Digital Versatile Disk (DVD), a Blu-ray (registered trademark) Disk (BD), and a flash memory.

The communication interface 105 connects the computer apparatus 100 and another apparatus to each other via the network 200 in a communicable manner. The communication interface 105 functions as the communication unit 13 in FIG. 1, for example.

The input/output interface 106 is, for example, an interface that can be connected to various types of input devices in a removable manner. Examples of the input device 107 connected to the input/output interface 106 include a keyboard and a mouse. The input/output interface 106 connects each of the various types of input devices connected thereto and the computer apparatus 100 to each other in a communicable manner. The input/output interface 106 outputs a signal input from each of the various types of input devices connected thereto to the control circuit 101 via the bus 110. The input/output interface 106 also outputs a signal output from the control circuit 101 to an input/output device via the bus 110. The input/output interface 106 and the input device 107 function as the operation unit 15 in FIG. 1, for example.

The display device 109 displays various types of information. The display device 109 is, for example, a CRT (Cathode Ray Tube), an LCD (Liquid Crystal Display), a PDP (Plasma Display Panel), and an OELD (Organic Electroluminescence Display). The network 200 is, for example, a LAN, wireless communication, a P2P network, or the Internet and communicably connects the computer apparatus 100 to other apparatuses.

The present embodiment is not limited to the embodiment described above and various configurations or embodiments can be conceived within the scope not departing from the gist of the present embodiment.

All examples and condition statements aided herein are intended for educational purposes to help the reader understand the concepts contributed by the inventor to further the invention and the art, and are to be construed as not limited to such specifically aided examples and conditions, and the construction of such examples is not relevant to depicting the superiority of the invention. While embodiments of the invention have been described in detail, it is to be understood that various changes, substitutions, and modifications may be made herein without departing from the spirit and scope of the invention.

### REFERENCE SIGNS LIST

1 image processing device, 100 computer device, 101 control circuit, 102 storage device, 103 read/write device, 104 recording medium, 105 communication interface, 106 input/output interface, 107 input device, 108 image control circuit, 109 display device, 110 bus, 200 network

What is claimed is:

1. An image processing apparatus comprising a learning unit configured to cause a machine learning model to perform the method according to claim 9.

2. An image processing apparatus comprising a learning unit configured to cause a machine learning model perform the method according to claim 10.

3. An image processing apparatus comprising:
a learning unit configured to cause a first machine learning model and a second machine learning model to perform the method according to claim 11; and
an inference unit configured to perform inference using the first machine learning model on target image data that is a target of image processing as input, to output a value based on the target image data, and
configured to perform inference using the second machine learning model on the output value and the target image data as input to generate output image data based on the target image data.

4. The image processing apparatus according to claim 1, wherein the value defines a degree of blur in an image.

5. The image processing apparatus according to claim 1, wherein the degradation processing is at least one of reduction, Gaussian blur, noise addition, and JPEG compression.

6. The image processing apparatus according to claim 1, wherein the learning unit causes the machine learning model to perform learning by using a portion of the processed image data which corresponds to a specific portion including a pixel satisfying a predetermined condition in an image obtained by filter processing performed on the processed image data.

7. The image processing apparatus according to claim 6, wherein the specific portion includes a region where a numerical value is large in the processed image data after filter processing.

8. The image processing apparatus according to claim 6, wherein the specific portion includes a region where a numerical value is small in the processed image data after filter processing.

9. An image processing method executed by a processor, comprising causing a machine learning model outputting a value in accordance with predetermined input image data to perform learning based on processed image data, obtained by degradation processing performed on image data based on a predetermined degradation processing parameter, and a value in accordance with the degradation processing parameter.

10. An image processing method executed by a processor, the method comprising causing a machine learning model generating output image data in accordance with predetermined input image data to perform learning based on processed image data, obtained by degradation processing performed on image data based on a predetermined degradation processing parameter, the image data, and a value in accordance with the degradation processing parameter.

11. An image processing method executed by a processor, the method comprising:
causing a first machine learning model capable of outputting a value in accordance with predetermined input image data to perform learning based on processed image data, obtained by degradation processing performed on image data based on a predetermined degradation processing parameter, and a value in accordance with the degradation processing parameter;
causing a second machine learning model generating image data in accordance with predetermined input image data to perform learning based on the image data, the processed image data, and the value in accordance with the degradation processing parameter;
performing inference using the first machine learning model on target image data that is a target of image processing as input, to output a value based on the target image data; and
performing inference using the second machine learning model on the output value and the target image data as input to generate output image data based on the target image data.

12. A non-transitory computer-readable recording medium storing a program for causing a processor to perform the method according to claim 9.

13. A non-transitory computer-readable recording medium storing a program for causing a processor to perform the method according to claim 10.

14. A non-transitory computer-readable recording medium storing a program for causing a processor to execute an image processing method according to claim 11.

15. The image processing apparatus according to claim 3, wherein the inference unit:
generates a processed value obtained by performing a predetermined process for the value output by the inference using the first machine learning model, and
generates the output image data by applying the processed value to an intermediate output of the inference using the second machine learning model.

16. The image processing apparatus according to claim 15, wherein the inference unit applies the processed value to a weighted region in the intermediate output.

17. The image processing apparatus according to claim 15, wherein the inference unit applies the processed value to a region corresponding to a position of an object in the intermediate output based on the position of the object in the target image data.
